(19) United States
(12) Patent Application Publication
(10) Pub. No.: US 2018/0054486 A1
(43) Pub. Date: Feb. 22, 2018

(54) Speculative Requests

(71) Applicant: International Business Machines Corporation, Armonk, NY (US)

(72) Inventors: Greg R. Dhuse, Chicago, IL (US); Jason K. Resch, Chicago, IL (US)

(21) Appl. No.: 15/802,633

(22) Filed: Nov. 3, 2017

Related U.S. Application Data
(63) Continuation-in-part of application No. 15/688,162, filed on Aug. 28, 2017.
Application No. 15/688,162 is a continuation-in-part of application No. 14/153,319, filed on Jan. 13, 2014, now Pat. No. 9,774,678.
Application No. 14/153,319 is a continuation-in-part of application No. 12/838,407, filed on Jul. 16, 2010, now Pat. No. 9,015,431.
(60) Provisional application No. 61/769,588, filed on Feb. 26, 2013.
(60) Provisional application No. 61/256,226, filed on Oct. 29, 2009.

(51) Int. Cl. H04L 29/08

(52) U.S. Cl. CPC H04L 67/1097

(57) ABSTRACT

A distributed storage (DS) unit, which is part of a distributed storage network (DSN), receives multiple speculative requests from another processing device also included in the DSN. Each of the speculative requests includes a request for the same action to be performed by the DS unit. The DS unit processes a first speculative request by acting on the request. Any redundant speculative requests from the second device that are received at the DS unit are ignored.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/688,162, entitled “DETERMINING HOW TO SERVICE REQUESTS BASED ON SEVERAL INDICATORS”, filed Aug. 28, 2017, which claims priority pursuant to 35 U.S.C. § 120 as a continuation-in-part of U.S. Utility application Ser. No. 14/153,319, entitled “TEMPORARILY STORING DATA IN A DISPERSED STORAGE NETWORK”, filed Jan. 13, 2014, issued as U.S. Pat. No. 9,774,678 on Sep. 26, 2017, which claims priority pursuant to 35 U.S.C. § 119(e) to U.S. Provisional Application No. 61/769,588, entitled “CONFIRMING INTEGRITY OF DATA IN A DISPERSED STORAGE NETWORK”, filed Feb. 26, 2013, all of which are hereby incorporated herein by reference in their entirety and made part of the present U.S. Utility Patent Application for all purposes.

U.S. Utility application Ser. No. 14/153,319 also claims priority pursuant to 35 U.S.C. § 120 as a continuation-in-part of U.S. Utility application Ser. No. 12/838,407, “DISTRIBUTED STORAGE REVISION ROLLBACKS”, filed Jul. 16, 2010, issued as U.S. Pat. No. 9,015,431 on Apr. 21, 2015, which claims priority pursuant to 35 U.S.C. § 119(e) to U.S. Provisional Application No. 61/256,226, entitled “DISTRIBUTED STORAGE NETWORK DATA REVISION CONTROL”, filed Oct. 29, 2009, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

Technical Field of the Invention

This invention relates generally to computer networks and more particularly to dispersing error encoded data.

Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

When using cloud storage, or other distributed storage networks, some storage devices included in the network may experience performance issues that hinder the timely completion of access or other requests associated with data storage or retrieval. Currently available systems may allow a storage device included in a network to be accessed by different communication paths. If one communication path malfunctions, a second communication path can be used for failover.

However, currently available systems with failover mechanisms may not adequately address performance level issues that do not rise to the level of complete failure of a communication path. And current techniques for selecting a failover path can introduce delays caused by waiting for confirmation that a communication path is no longer functioning.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a dispersed storage network in accordance with the present invention; and

FIG. 10 is a flowchart illustrating an example of accessing a dispersed storage unit in accordance with the present invention.

### DETAILED DESCRIPTION OF THE INVENTION

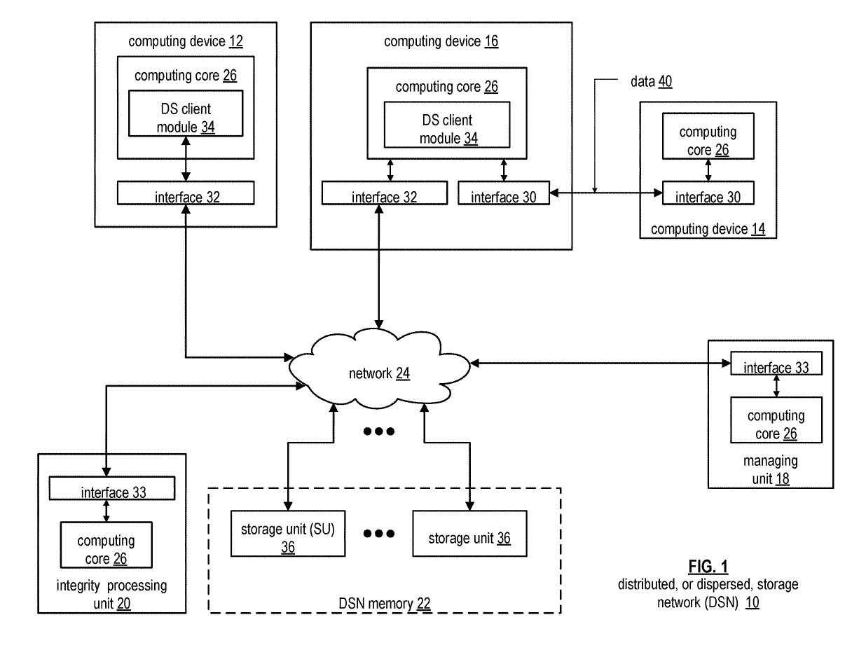

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

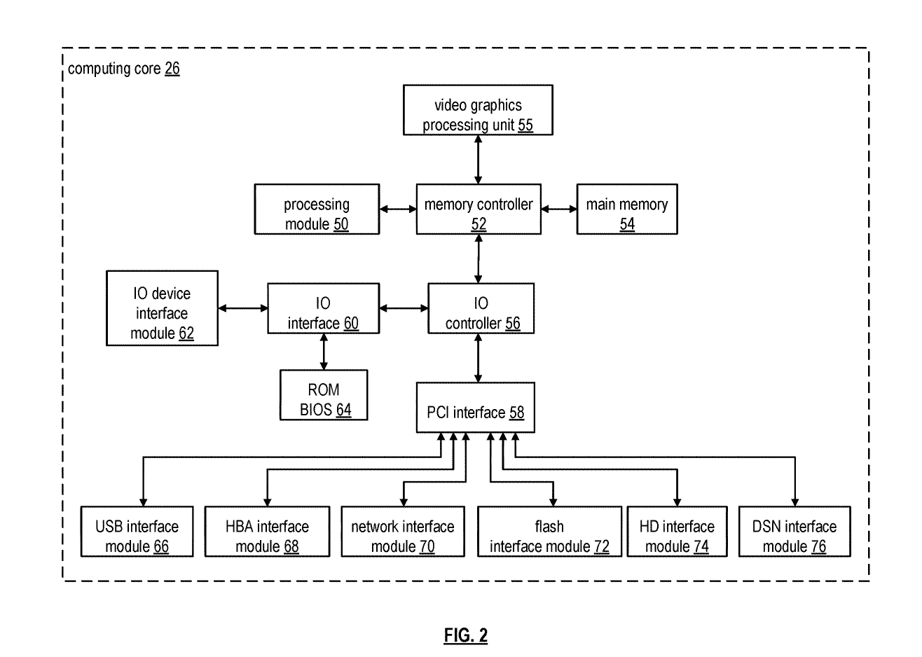

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

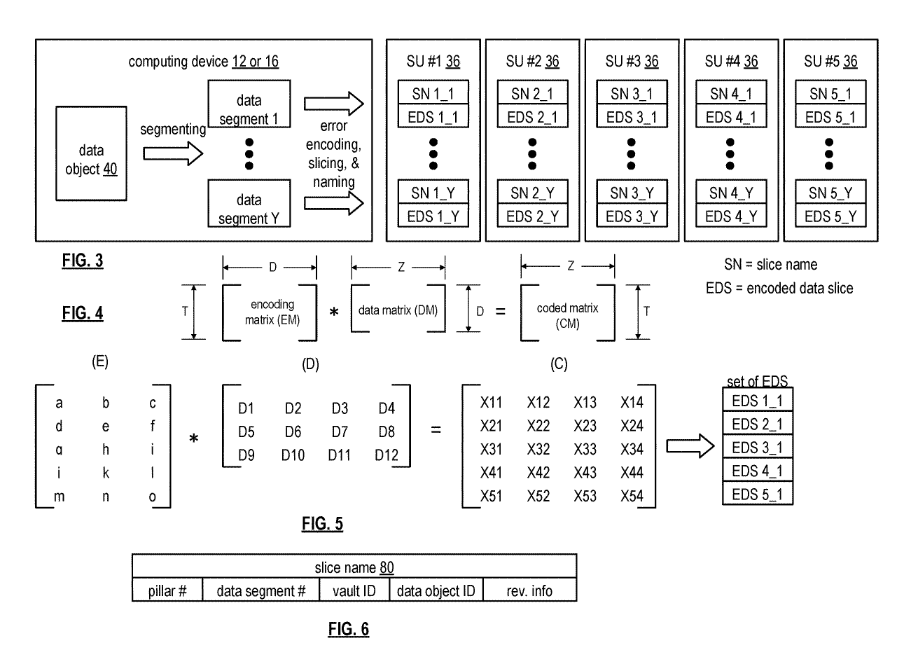

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

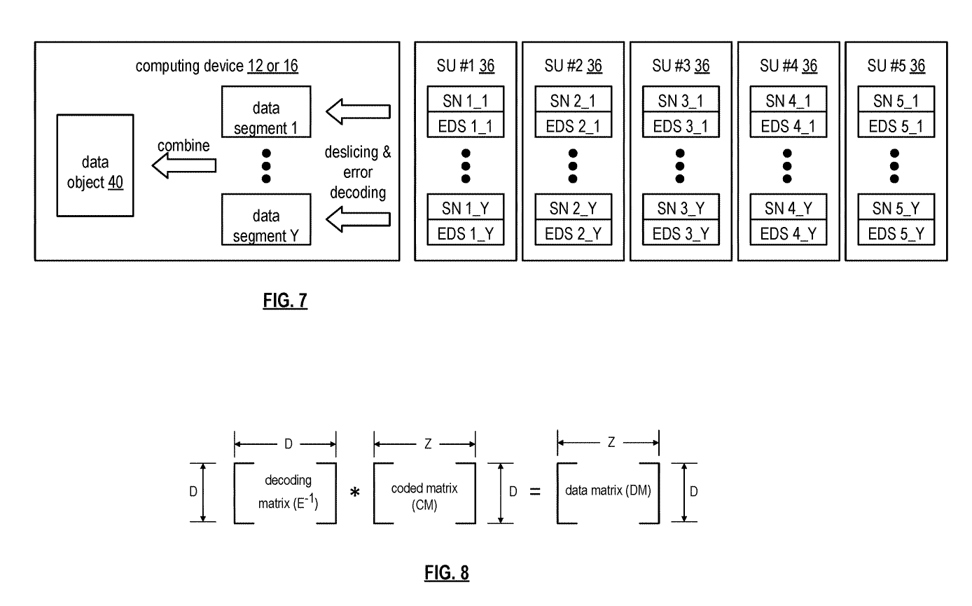

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1−T), a data segment number (e.g., one of 1−Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

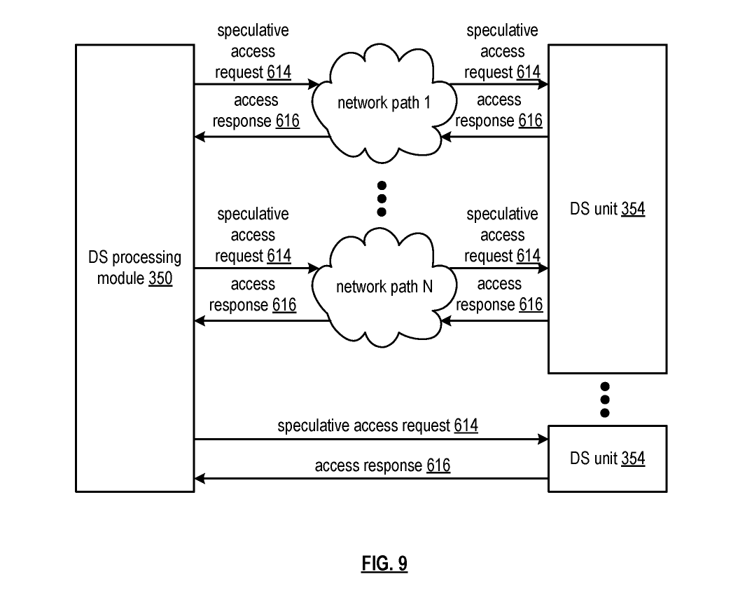

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

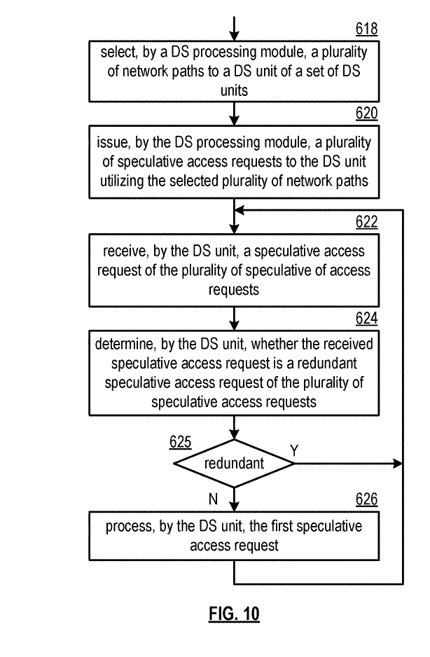

Referring next to FIGS. 9 and 10, various systems and techniques for implementing speculative requests in a dispersed/distributed storage network will be discussed. In various embodiments, multiple requests, for example data access requests, slice rebuild requests, requests for status verification, or the like, are sent from a requestor to storage unit. Each of these speculative requests is for the same storage unit to perform the same action. For example, four requests to read or write the same piece of data can be sent by the same device to the same storage unit. These requests can be sent by the requesting device concurrently or sequentially, without waiting for the target device to acknowledge receipt of any of the messages. Thus, all four requests can be transmitted at substantially the same time by the requesting device.

Each of the requests can have a common identifier (such as the same sequence number, or other unique identifier), and optionally, an indicator that identifies the request as “speculative.” The requests may be issued along different connections, different network paths, different network interfaces, or along different media.

The DS unit, upon receipt of any of the speculative requests, will process the first message it receives, but ignore any “redundant” requests that share the common identifier and not process them. Processing the speculative request includes acting on the request. For example, attempting to honor the write request. Note that even if the write request cannot be performed, for example because the data identified in the request is subject to a data lock, the receiving storage unit is still said to have acted on, or processed, the request. If the request is ignored, the DS unit will not even attempt to honor the write request.

In various embodiments, the DS unit will remember the identifiers for the speculative requests it has processed for some window of time, which may be less than the life of the session or connection. An example situation when a requester might use speculative requests is situations where the request is small (read request, list request, check request, commit request etc.) and minimum latency is desired. In such a case, a requester may issue the speculative request along multiple currently established connections between the requester and the DS unit, so that even unidentified communication path issues can be bypassed.

FIG. 9 is a schematic block diagram of an embodiment of a dispersed storage network that includes the dispersed storage (DS) processing module 350 (e.g. computing device 12, 16, 14 or DSN memory 22 of FIG. 1), a plurality of DS units 354 (e.g. storage unit 36 or DSN memory 22 of FIG. 1), and N network paths via one or more networks to operably couple the DS processing module 350 to the plurality of DS units 354. The one or more networks may be implemented with the network 24 of FIG. 1. The network paths 1-N exhibit a variety of performance levels when operably coupling the DS processing module 350 to each of the plurality of DS units 354. Each DS unit 354 of the plurality of DS units 354 may utilize one or more network paths of the network paths 1-N to operably couple to the DS processing module 350. For example, a first network path of the network paths 1-N exhibits lower latency to communicate requests and responses between the DS processing module 350 and a first DS unit 354 of the plurality of DS units 354 as compared to exhibited latency of a second network path of the network paths 1-N.

The system functions to optimize data access performance to data stored in the plurality of DS units 354 by a selection and utilization of network paths 1-N. The DS processing module 350 selects a plurality of network paths of the network paths 1-N to a DS unit 354 of the set of DS units 354. The selecting may be based on one or more of a predetermination, an error message, an estimated performance level, a measured performance level, a security requirement, a bandwidth availability indicator, and a request. For example, the DS processing module 350 selects a plurality of network paths to each DS unit 354 of the set of DS units 354 such that a set of the plurality of network paths is estimated to exhibit substantially the same latency performance levels.

When accessing the data, the DS processing module 350 issues a plurality of speculative access requests 614 to each DS unit 354 of the set of DS units 354 via a corresponding selected plurality of network paths. For each of the set of pluralities of speculative access requests 614, the DS processing module 350 generates each speculative access request to include one or more of a common sequence number, a speculative request indicator, and a dispersed storage network (DSN) address associated with an encoded data slice of the speculative access request. Each DS unit 354 receives a first speculative access request 614 (e.g., first received) of the corresponding plurality of speculative access requests 614 and processes the first speculative access request 614 (e.g., write a slice, delete a slice, read a slice, generate an access response 616, and outputs the access response 616 to the DS processing module). During an exclusion time frame, the DS unit 354 ignores subsequent speculative access requests 614 that are redundant with respect to the first speculative access request 614 (e.g., redundant when the subsequent speculative access request includes the common sequence number).

FIG. 10 is a flowchart illustrating another example of accessing a dispersed storage unit. The method begins at step 618 where a dispersed storage (DS) processing module selects a plurality of network paths to a DS unit of a set of DS units. The selecting of the plurality of network paths to the DS unit may be based on one or more of a predetermination, an error message, a performance level of the path to the DS unit, a performance level of another path to another DS unit where the other DS unit and the DS unit are included in the set of DS units, a security requirement, a bandwidth availability indicator, a prior selection, a prior performance level, and a request.

The method continues at step 620 where the DS processing module issues a plurality of speculative access requests to the DS unit utilizing the selected the plurality of network paths. The issuing includes determining a number of speculative access requests based on one or more of a previous number of speculative access requests for the set of DS units, a performance level of the set of DS units, a predetermination, and a request. Each speculative access request includes a common sequence number or a speculative request indicator, and a dispersed storage network (DSN) address associated with an encoded data slice of the speculative access request. The DS processing module may also issue another plurality of speculative access requests to one or more other DS units of the set of DS units.

The method continues at step 622 where a DS unit of the set of DS units receives a speculative access request of the plurality of speculative access requests. The method continues at step 624 where the DS unit determines whether the received speculative access request is a redundant speculative access request of the plurality of speculative access requests. The DS unit indicates that the received speculative access request is redundant when another speculative access request that includes the common sequence number was received within an exclusion time frame.

As illustrated at step 625, the method loops back to step 622 when the received speculative access request is redundant, and continues to step 626 when the DS unit determines that the received speculative access request is not redundant. The method continues at step 626 where the DS unit processes the first speculative access request when the received speculative access request is not redundant. The processing of the first speculative access request includes activating the exclusion time frame for the common sequence number. The method may loop back to step 622.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for use in a first processing device configured to implement a distributed storage (DS) unit included in a distributed storage network (DSN), the method comprising:
receiving, at the DS unit, a plurality of speculative requests from a second processing device included in the DSN, wherein each of the plurality of speculative requests includes a request for a same action to be performed by the DS unit;
processing, by the DS unit, a first speculative request of the plurality of speculative requests from the second processing device, wherein the processing includes acting on the request for the same action; and
ignoring, by the DS unit, redundant speculative requests of the plurality of speculative requests from the second processing device.

2. The method of claim 1, further comprising:
receiving at least two of the speculative requests via different network paths coupling the second processing device to the DS unit.

3. The method of claim 1, further comprising:
identifying speculative requests by determining, at the DS unit, that each of the plurality of speculative requests includes a common identifier.

4. The method of claim 1, further comprising:
identifying speculative requests by determining, at the DS unit, that each of the plurality of speculative requests includes a speculative request indicator.

5. The method of claim 1, further comprising:
maintaining, by the DS unit, a record identifying speculative requests processed by the DS unit during an exclusion time frame.

6. The method of claim 5, further comprising:
activating the exclusion time frame; and
ignoring the redundant speculative requests only during the exclusion time frame.

7. The method of claim 1, wherein the processing includes:
transmitting, by the DS unit, an access response to the second processing device.

8. A distributed storage (DS) unit for use in a distributed storage network (DSN), the DS unit comprising:
at least one communications interface configured to receive a plurality of speculative requests from requesting computing device included in the DSN, wherein each of the plurality of speculative requests includes a request for a same action to be performed by the DS unit;
a computing core including a processor and associated memory, the computing core configured to:
process a first speculative request of the plurality of speculative requests, wherein processing the first speculative request includes acting on the first speculative request; and
ignore redundant speculative requests of the plurality of speculative requests.

9. The DS unit of claim 8, further comprising a plurality of communications interfaces coupling the requesting computing device to the DS unit, wherein:
a first communications interface is configured to receive a first speculative request via a first network path; and
a second communications interface is configured to receive a redundant speculative request via a second network path.

10. The DS unit of claim 8, the computing core further configured to:
identify speculative requests by determining that each of the plurality of speculative requests includes a common identifier.

11. The DS unit of claim 8, the computing core further configured to:
identify speculative requests by determining that each of the plurality of speculative requests includes a speculative request indicator.

12. The DS unit of claim 8, the computing core further configured to:
maintain a record identifying speculative requests processed by the DS unit during an exclusion time frame.

13. The DS unit of claim 12, the computing core further configured to:
activate the exclusion time frame; and
ignore the redundant speculative requests only during the exclusion time frame.

14. The DS unit of claim 8, the computing core further configured to:
transmit an access response to the requesting computing device via the at least one communications interface.

15. A distributed storage network (DSN) comprising:
at least one distributed storage (DS) unit;
a DS processing module coupled to the at least one DS unit via a plurality of network paths, the DS processing module configured to transmit a plurality of speculative data access requests to the at least one DS unit, wherein each of the plurality of speculative data access requests includes a request for a same action to be performed by the DS unit;
the DS unit including:
at least one communications interface configured to receive the plurality of speculative data access requests from the DS processing module;
a computing core including a processor and associated memory, the computing core configured to:
process a first speculative data access request, wherein processing the first speculative data access request includes attempting to perform the first speculative data access request; and
ignore redundant speculative data access requests.

16. The distributed storage network (DSN) of claim 15, the DS unit further comprising a plurality of communications interfaces coupling the DS processing module to the DS unit, wherein:
a first communications interface of the DS unit is configured to receive a first speculative data access request via a first network path; and
a second communications interface is configured to receive a redundant speculative data access request via a second network path.

17. The distributed storage network (DSN) of claim 15, the computing core further configured to:
identify speculative data access requests by determining that each of the plurality of speculative data access requests includes a common identifier.

18. The distributed storage network (DSN) of claim 15, the computing core of the DS unit further configured to:
identify speculative data access requests by determining that each of the plurality of speculative data access requests includes a speculative request indicator.

19. The distributed storage network (DSN) of claim 15, the computing core of the DS unit further configured to:
maintain a record identifying speculative data access requests processed by the DS unit during an exclusion time frame.

20. The distributed storage network (DSN) of claim 19, the computing core of the DS unit further configured to:
activate the exclusion time frame in response to processing the first speculative data access request; and
ignore the redundant speculative data access requests only during the exclusion time frame.
